(19) United States
(12) Patent Application Publication
(10) Pub. No.: US 2023/0080857 A1
(43) Pub. Date: Mar. 16, 2023

(54) AUDIO-VISUAL OFFSET PROCESS

(71) Applicant: SoClip!, Bandol (FR)

(72) Inventor: Christophe Vaucher, Bandol (FR)

(21) Appl. No.: 17/932,503

(22) Filed: Sep. 15, 2022

Related U.S. Application Data
(60) Provisional application No. 63/244,964, filed on Sep. 16, 2021.

(51) Int. Cl. G11B 27/10; G06F 3/16

(52) U.S. Cl. CPC G11B 27/10; G06F 3/165

(57) ABSTRACT

The present technology can provide a mechanism for generating an offset based on protocols that are used for delivering a digital multimedia content to correct a latency between an audio and visual experience of a digital multimedia content. A wireless audio transport latency may be determined based on whether there is a wireless audio transport playback protocol for the digital multimedia file. An encoding image latency may be determined based on whether the digital multimedia file is encoded. A total audio latency offset may be calculated based on a retinal image latency in addition to the encoding image latency minus the wireless audio transport latency. The retinal image latency is based on the persistence of vision.

### CROSS-REFERENCE TO RELATED APPLICATION

This application claims priority to U.S. Provisional Application No. 63/244,964 filed Sep. 16, 2021, which is incorporated by reference herein in its entirety.

### FIELD

The present technology generally relates to a method for audio-visual synchronization, and in particular, for determining an audio latency offset for compensating a latency differential in an audio-visual experience by a user.

### BRIEF DESCRIPTION OF THE DRAWINGS

FIG. 1 conceptually illustrates an example diagram showing that a visual component comprising a series of still images and an audio component of a digital multimedia file may be played at an offset in order to account for latency, according to some aspects of the disclosed technology.

FIG. 2 conceptually illustrates an example diagram showing how playing the visual component and the audio component at an offset allows for sound and the associated images to be realigned and synchronized at a human brain, according to some aspects of the disclosed technology.

FIG. 3 illustrates an example diagram showing an audio latency between the visual component and the audio component that is due to a delay caused by wireless audio transport, according to some aspects of the disclosed technology.

FIG. 4 illustrate an example diagram showing how there is an image latency between the visual component and the audio component when the digital multimedia content is encoded, according to some aspects of the disclosed technology.

FIG. 5 illustrates an example diagram showing that various latencies may be compensated by a total audio latency offset, according to some aspects of the disclosed technology.

FIG. 6 illustrates an example process for offsetting a delay between an audio and visual experience of a digital multimedia file, according to some aspects of the disclosed technology.

FIG. 7 illustrates an example processor-based system with which some aspects of the subject technology can be implemented.

### SUMMARY

Disclosed are systems, apparatuses, methods, computer-readable medium, and circuits for offsetting a delay between an audio and visual experience of a digital multimedia file. According to at least one example, a method includes: receiving the digital multimedia file; determining whether there is a wireless audio transport latency based on whether there is a wireless audio transport protocol for the digital multimedia file; determining whether there is an encoding image latency based on whether the digital multimedia file is encoded; calculating a total audio latency offset based on a retinal image latency in addition to the encoding image latency minus the wireless audio transport latency; and shifting a series of still images of the digital multimedia file forward in time by the total audio latency offset. In some cases, the determining of whether there is the wireless audio transport protocol includes a check for whether a processing device performing playback of the digital multimedia file is connected to a wirelessly-connected audio output. In some cases, when audio is no longer played via the wirelessly-connected audio output, the total audio latency offset may be re-adjusted to remove the wireless audio transport latency.

In another example, a program for offsetting a delay between an audio and visual experience of a digital multimedia file is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the program to: receive the digital multimedia file; determining whether there is a wireless audio transport latency based on whether there is a wireless audio transport protocol for the digital multimedia file; determining whether there is an encoding image latency based on whether the digital multimedia file is encoded; calculating a total audio latency offset based on a retinal image latency in addition to the encoding image latency minus the wireless audio transport latency; and delaying an audio by the total audio latency offset.

### DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Aspects of the disclosed technology provide solutions to offset a delay between an audio and visual experience of a digital multimedia content. Because of an optical phenomenon known as persistence of vision, the human eye and brain can only process 10 to 12 separate images per second. In other words, there is a latency of an image build-up in a human retina, ranging between approximately 50 to 100 milliseconds or more. Because of such an offset, if a video content, comprised of still images interlaced at some frame rate, is played at a same as a synchronized audio content, there would be an offset between when one of the still images reaches the retina and a synchronized sound artefact associated with that still image, as the sound is transferred to the brain in much less time than an image is transferred to the brain. For a digital multimedia content, such as music videos, where the beats of the music need to accurately match transitions or visual events (typically by less than 30 ms), such an offset may diminish an intended powerful impact or conjured emotion based on a synchronized audio-visual experience.

In some implementations, the disclosed technology also considers an audio latency due to conversion, sending, or reading of an audio flow. Such an audio latency may range from approximately 50 to 200 milliseconds but may be more or less. Because of such audio transport latency in wireless transmission, there may be a sound delay such that the audio content is delayed, causing the sound to reach a human cochlea after its associated still image. In addition, in some implementations, the disclosed technology also considers a possible image latency if there is required encoding/decoding. Such an image latency may range from approximately 25 to 75 milliseconds, but may be more or less. Therefore, there may be a total audio latency offset that is determined based on persistence of vision, and whether there is an offset due to wireless audio transport and/or encoding/decoding.

Additional details regarding processes for analyzing and identifying audio artifacts in a musical composition (e.g., an audio file) are discussed in relation to U.S. application Ser. No. 16/503,379, entitled “BEAT DECOMPOSITION TO FACILITATE AUTOMATIC VIDEO EDITING,” which is herein incorporated by reference in its entirety. As discussed in further detail below, aspects of the technology can be implemented using an API and/or a software development kit (SDK) that are configured to automatically set an offset based on experienced audiovisual latency, which may be determined by settings and conditions associated with playback of an audiovisual content.

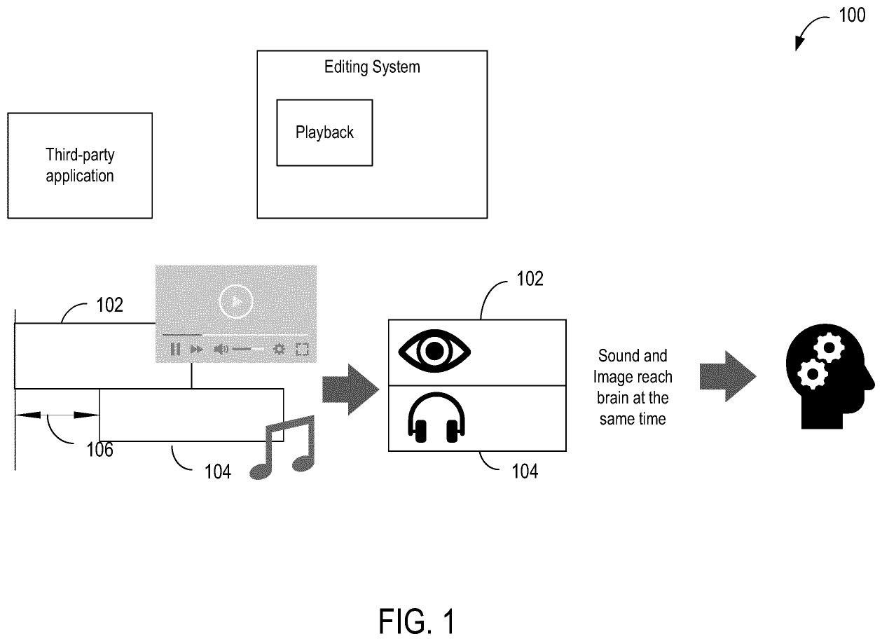

FIG. 1 illustrates an example diagram 100 showing that a visual component 102 comprising a series of still images and an audio component 104 of a digital multimedia file may be played at an offset 106 in order to account for latency for various reasons, including some that are discussed further below. By way of example, the digital multimedia file may include MP3, MP4, or WAV encoded content. The offset 106 may allow the sound and images to reach a human brain at a same time, allowing for a perfectly synchronous audiovisual experience. Otherwise, there may be a subconscious cognitive burden on the human brain to adjust for the audiovisual asynchronization.

A professional editor of a video may set and perfectly align the visual component 102 and the audio component 104 in a timeline-based video editing software application and intend for the visual component 102 and the audio component 104 to be received synchronously. However, given factors such as persistence of vision, wireless audio transport, and/or encoding/decoding, post-production latency may still cause audiovisual asynchronization and thus needs to be accounted for upon playback of the digital multimedia file.

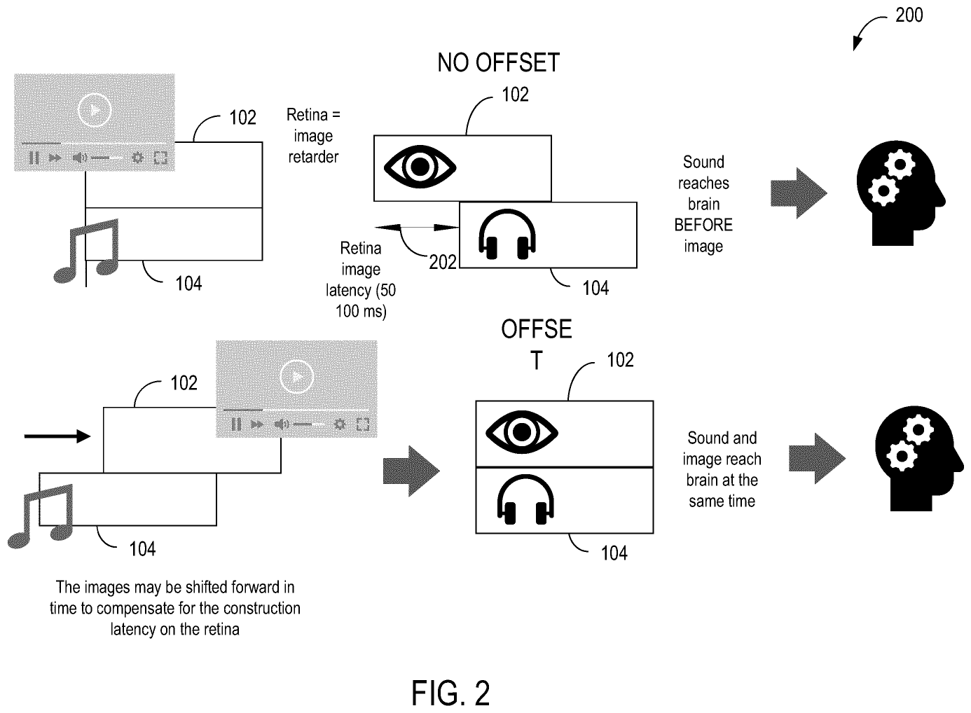

FIG. 2 illustrates an example diagram 200 showing how playing the visual component 102 and the audio component 104 at an offset allows for sound and the associated images to be realigned and synchronized at a human brain, according to some aspects of this disclosure. In particular, because of persistence of vision at the human retina, there is a retina image latency 202, of approximately 50 to 100 milliseconds or more, for every still image of a series of still images of a video. Therefore, when the visual component 102 and the audio component 104 are played at a same time, the sound reaches the human brain before an associated image by approximately 50 to 100 milliseconds or more.

However, if the visual component 102 and the audio component 104 are played at an offset 204 of approximately 50 to 100 milliseconds or more, whereby the images are shifted forward by approximately 50 to 100 milliseconds or more, the sound and image reaches the brain at the same time. An algorithm may be used to dynamically calculate how much to set as the offset 204, such as based on the complexity of the images, or the offset 204 may be set with a default of 100 milliseconds. The offset 204 may be set in an SDK and/or in a software application, wherein the offset 404 may be tuned to different values.

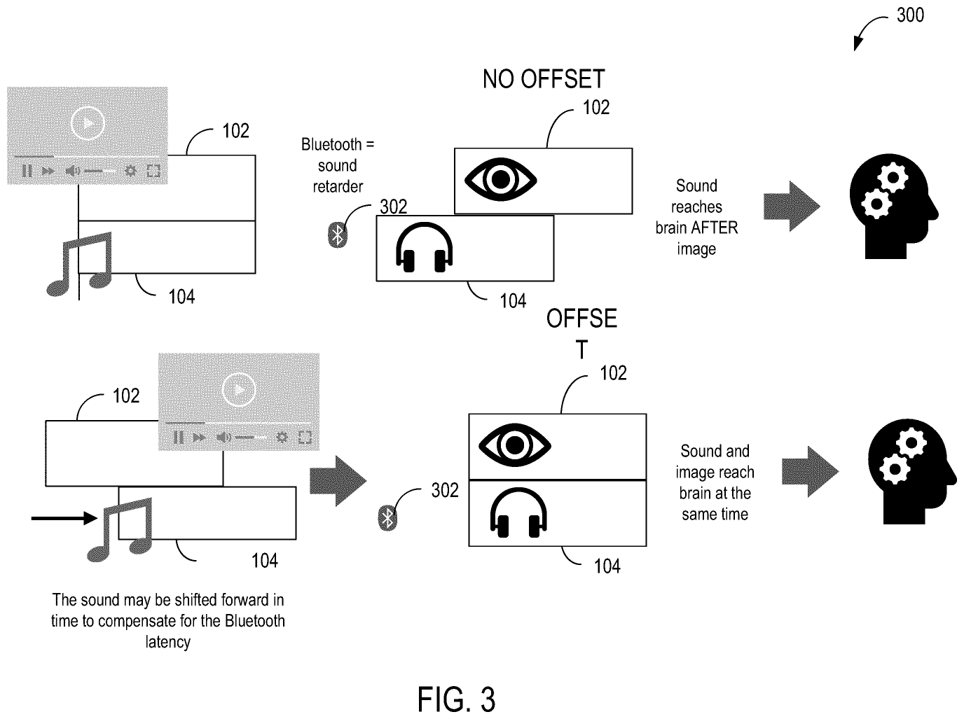

FIG. 3 illustrates an example diagram 300 showing an audio latency between the visual component 102 and the audio component 104 that is due to a delay caused by wireless audio transport, according to some aspects of this disclosure. For a wireless connection, such as a Bluetooth connection, a wireless audio transport latency 302 may range from 50 to 300 milliseconds for true wireless earbuds and headphones. Therefore, when the visual component 102 and the audio component 104 are played at a same time, if there were no other considerations, the sound would reach the human brain after an associated image by approximately 50 to 300 milliseconds.

However, if the visual component 102 and the audio component 104 are played at an offset 304 of approximately 50 to 300 milliseconds, whereby the sound is shifted forward by approximately 50 to 300 milliseconds or more, the sound and image would reach the brain at the same time, if there were no other considerations. The offset 304 may be set with a default of 100 milliseconds or may be set based on real time OS measurements or known latency values associated with an earbud, headphone, or any wireless audio device connected to a playback system or device. The offset 304 may be set in a software development kit (SDK) and/or in a software application, wherein the offset 404 may be tuned to different values.

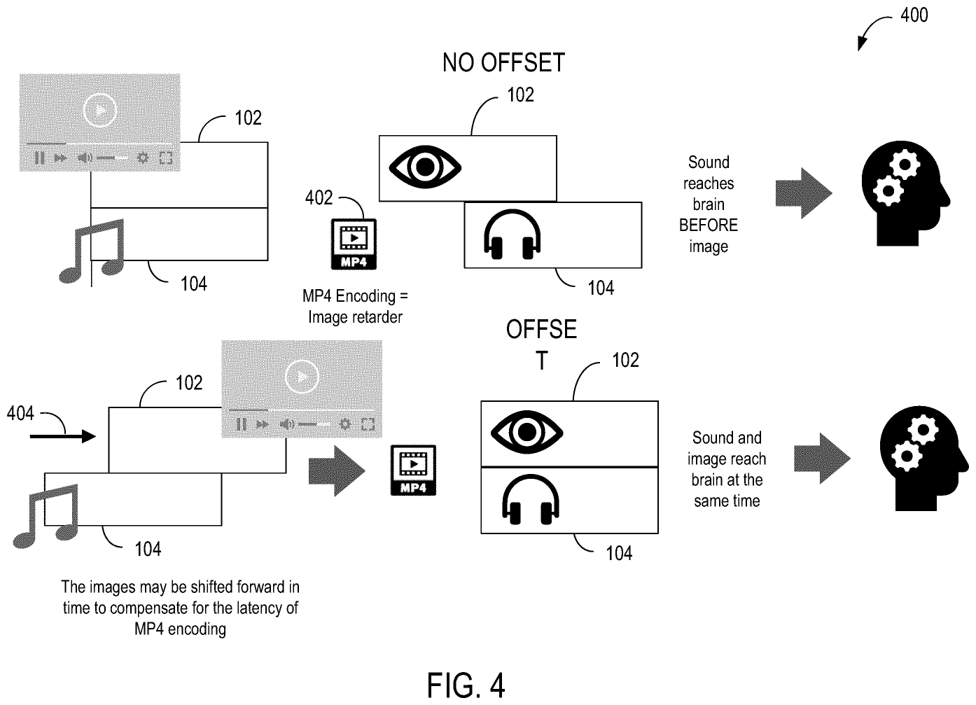

FIG. 4 illustrates an example diagram 400 showing how there is an image latency between the visual component 102 and the audio component 104 when the digital multimedia content is encoded, according to some aspects of this disclosure. In particular, encoding a digital multimedia file into a certain format may cause encoding image latency 402 depending on the encoder/decoder. For example, if the digital multimedia file is encoded on a Windows PC, the offset may be 25 milliseconds with FFmpeg. Therefore, when the visual component 102 and the audio component 104 are played at a same time, if there were no other considerations, the sound would reach the human brain before an associated image by approximately 25 milliseconds, for example.

However, if the visual component 102 and the audio component 104 are played at an offset 404 of approximately 25 milliseconds, for example, whereby the sound is shifted forward by approximately 25 milliseconds or more, the sound and image would reach the brain at the same time, if there were no other considerations. The offset 404 may be set with a default of 25 milliseconds or may be set based on known latency values associated with the applied encoder/decoder. The offset 404 may be set in a software development kit (SDK) and/or in a software application, wherein the offset 404 may be tuned to different values.

Providing the offset 204, offset 304, or offset 404 are merely examples of kinds of offsets that may be set. Delays associated with other type of data transport mechanisms may be taken into consideration for setting offsets.

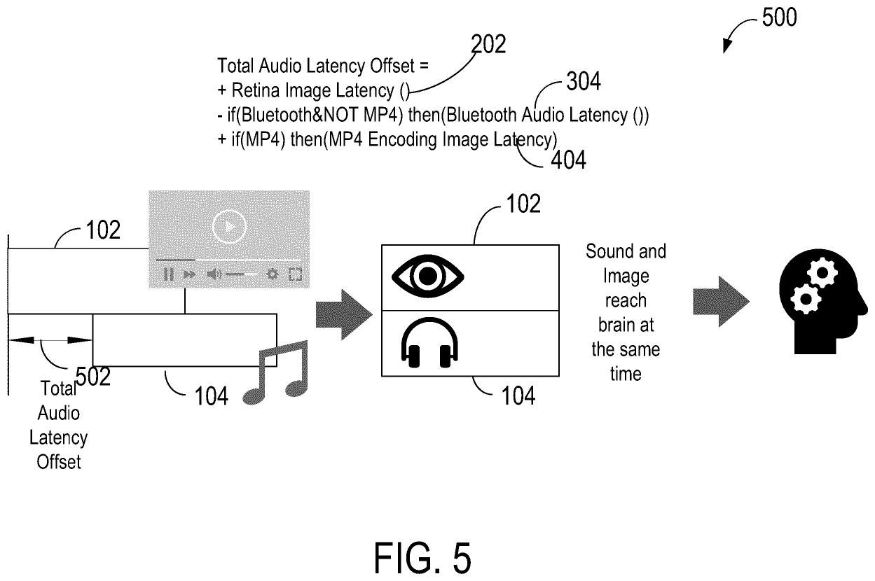

FIG. 5 illustrates an example diagram 500 showing that the various latencies described above may be compensated by a total audio latency offset 502, according to some aspects of this disclosure. In particular, the retinal image latency 202 in addition to the encoding image latency 402, if applicable, and less the wireless audio transport latency 302, if applicable, may equal the total audio latency offset 502. Certain latencies associated with the encoding image latency 402 or the wireless audio transport latency 302 may be determined based on the protocols that are used for delivering the digital multimedia content. A software application that enables playback of digital multimedia may receive a digital multimedia file. The digital multimedia file may be received and the context in which the digital multimedia file is played or encoded may be used to determine a total audio latency offset, that is then used to shift the visual component, typically a series of still images to be rendered at a certain frame rate, digital multimedia file.

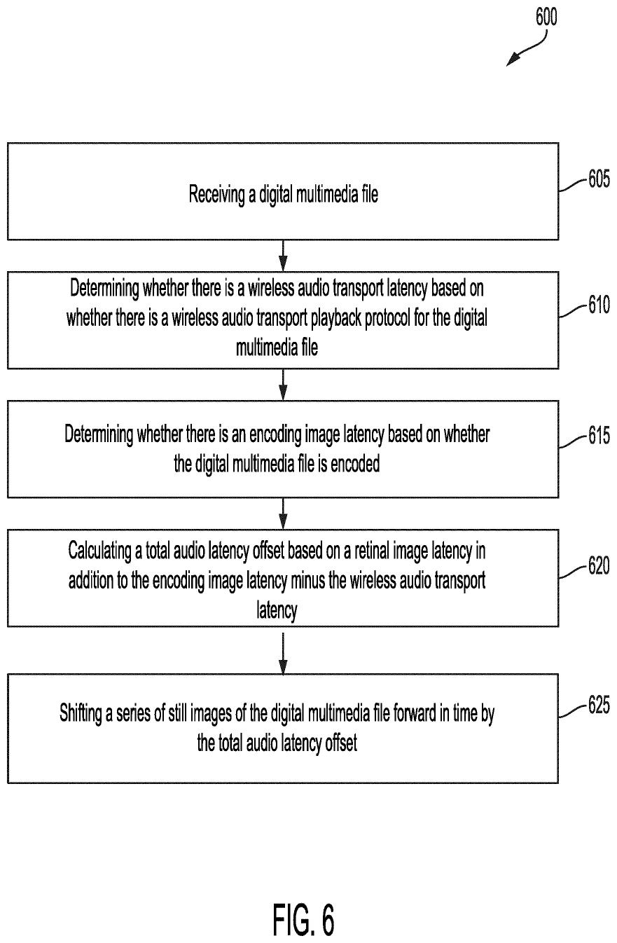

FIG. 6 illustrates steps of an example process 600 for generating an offset based on protocols that are used for delivering a digital multimedia content, according to some aspects of the disclosed technology. Process 600 begins with step 605, in a digital multimedia file is received, for example, at a multimedia editing platform including playback service or at a multimedia playback platform. In some implementations, one or more still images (digital pictures) may be received in addition to one or more songs, in the form of a music video. Depending on the desired implementation, the multimedia editing or playback platform may be implemented as an application, for example, that is executed on a server, and/or executed using a number of distributed computing nodes, for example, in a cloud infrastructure. In some respects, all (or portions) of the multimedia editing or playback platform functionality may be hosted on a mobile processing device, such as a smart phone, notebook, or tablet computer, etc.

In some respects, the audio file may contain one or more songs, for example, that are intended to be synced to the visual component, a series of still images to be rendered at a certain frame rate to display a video. The intended syncing may be based on an alignment of the audio file and the video file in a timeline-based video editing software application. However, as mentioned above, post-production issues may cause the audiovisual experience to be unsynced at the human brain if not corrected.

In step 610, a wireless audio transport latency and/or a wireless video transport latency may be determined based on whether there is a wireless audio transport playback protocol or wireless video transport playback protocol, respectively, for the digital multimedia file. The determination of whether there is a wireless audio transport playback protocol may be a check for whether the processing device performing the playback is connected to a wirelessly-connected audio output. If there is a wireless video transport playback protocol, the video flow may include one or more time references and latencies may be determined according to the one or more time references of the video flow. In some aspects, wirelessly-connected audio outputs may include BLUETOOTH®, AIRPLAY®, CHROMECAST®, or any other wirelessly-connected audio output. Depending on the kind of wirelessly-connected audio output, the processing application, such as via an SDK, may elect for a particular offset amount, such as between 100 to 300 milliseconds, or for a default offset amount, such as 100 milliseconds.

In step 615, an encoding image latency may be determined based on whether the digital multimedia file is encoded. Encoded digital multimedia files, requiring encoding and decoding, may cause latency. Once it is determined that the digital multimedia file is encoded, the processing application, such as via the SDK, may elect for a particular offset amount or a default offset amount, such as 50 milliseconds, depending on the kind of encoding. In some respects, the video coding format may be in a MP4 file format for which there is approximately a 50-millisecond image latency.

In step 620, a total audio latency offset may be calculated based on a retinal image latency in addition to the encoding image latency minus the wireless audio transport latency. The retinal image latency is based on the persistence of vision and causes approximately an offset of approximately 50 to 100 milliseconds. The processing application, such as via the SDK, may elect for a particular offset amount or a default offset amount, such as 100 milliseconds. Then, the processing application takes the elected offset associated with the retinal image latency, adds the elected offset associated with encoding image latency, and subtracts the elected offset associated with the wireless audio transport latency to determine the total audio latency offset.

In step 625, once the total audio latency offset is determined, a series of still images of the digital multimedia file is shifted forward in time by the total audio latency offset during playback. In some aspects, rather than shifting the images forward in time, the audio file may be delayed by the total audio latency offset. The determination of the total audio latency offset may be dynamic such that if, for example, the audio is no longer played via a wirelessly-connected audio output, the total audio latency offset may be adjusted such that the audiovisual experience at the human brain remains to be synchronized.

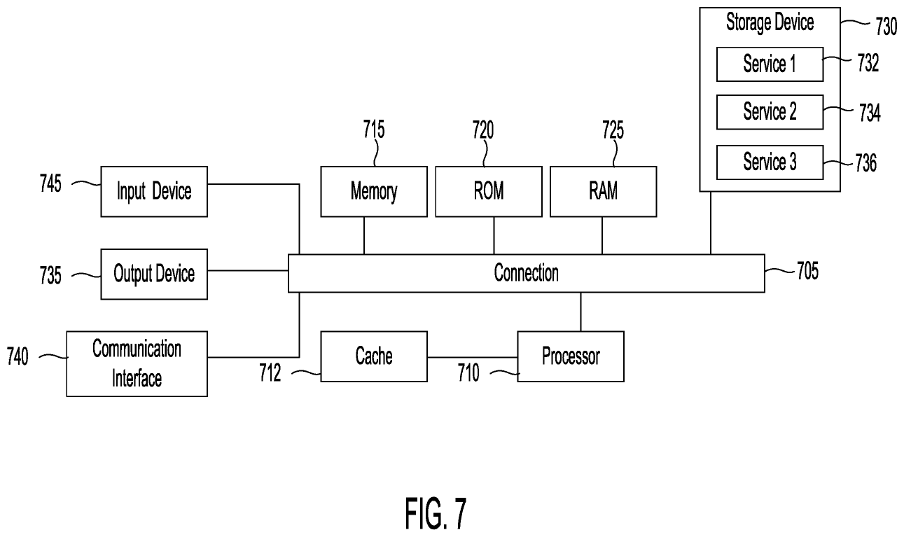

FIG. 7 illustrates an example processor-based system with which some aspects of the subject technology can be implemented. For example, processor-based system 700 that can be any computing device that is configured to generate and/or display customized video content for a user and/or which is used to implement all, or portions of, a multimedia editing/playback platform, as described herein. By way of example, system 700 can be a personal computing device, such as a smart phone, a notebook computer, or a tablet computing device, etc. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, and/or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

By way of example, processor 710 may be configured to execute operations for automatically determining an offset based on circumstantial factors, such as protocols that are used for delivering the digital multimedia content. By way of example, processor 710 may be provisioned to execute any of the operations discussed above with respect to process 600, described in relation to FIG. 6. By way of example, processor 710 may be configured to receive a digital multimedia file. In some aspects, processor 710 may be further configured for determine whether there is a wireless audio transport playback protocol for the digital multimedia file.

In some aspects, processor 710 may be further configured for determining whether there is an encoding image latency based on whether the digital multimedia file is encoded. In some aspects, processor 710 can be further configured to calculate a total audio latency offset based on a retinal image latency in addition to the encoding image latency minus the wireless audio transport latency. In some aspects, processor 710 may be further configured to execute operations for shifting a series of still images of the digital multimedia file forward in time by the total audio latency offset.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

What is claimed is:

1. A computer-implemented method for offsetting a delay between an audio and visual experience of a digital multimedia file, comprising:
receiving the digital multimedia file;
determining whether there is a wireless audio transport latency based on whether there is a wireless audio transport protocol for the digital multimedia file;
determining whether there is an encoding image latency based on whether the digital multimedia file is encoded;
calculating a total audio latency offset based on a retinal image latency in addition to the encoding image latency minus the wireless audio transport latency; and
shifting a series of still images of the digital multimedia file forward in time by the total audio latency offset.

2. The computer-implemented method of claim 1, wherein the determining of whether there is the wireless audio transport protocol includes a check for whether a processing device performing playback of the digital multimedia file is connected to a wirelessly-connected audio output.

3. The computer-implemented method of claim 2, further comprising:
when audio is no longer played via the wirelessly-connected audio output, the total audio latency offset is re-adjusted to remove the wireless audio transport latency.

4. The computer-implemented method of claim 1, further comprising:
determining the digital multimedia file is encoded; and
electing an offset amount for the encoding image latency depending on a kind of the encoding.

5. The computer-implemented method of claim 4, wherein the offset amount is set by a Software Development Kit (SDK).

6. The computer-implemented method of claim 1, wherein the retinal image latency is an offset of approximately 50 to 100 milliseconds.

7. The computer-implemented method of claim 1, further comprising:
determining there is a wireless video transport playback protocol, wherein a video flow includes one or more time references; and
determining latencies according to the one or more time references of the video flow.

8. A system for offsetting a delay between an audio and visual experience of a digital multimedia file comprising:
one or more processors; and
a computer-readable medium coupled to the processors, the computer-readable medium comprising instructions stored therein, which when executed by the processors, cause the processors to perform operations comprising:
receiving the digital multimedia file;
determining whether there is a wireless audio transport latency based on whether there is a wireless audio transport protocol for the digital multimedia file;
determining whether there is an encoding image latency based on whether the digital multimedia file is encoded;
calculating a total audio latency offset based on a retinal image latency in addition to the encoding image latency minus the wireless audio transport latency; and
delaying an audio by the total audio latency offset.

9. The system of claim 8, wherein the determining of whether there is the wireless audio transport protocol includes a check for whether a processing device performing playback of the digital multimedia file is connected to a wirelessly-connected audio output.

10. The system of claim 9, wherein the processors are further configured to execute operations comprising:
when the audio is no longer played via the wirelessly-connected audio output, the total audio latency offset is re-adjusted to remove the wireless audio transport latency.

11. The system of claim 8, wherein the processors are further configured to execute operations comprising:
determining the digital multimedia file is encoded; and
electing an offset amount for the encoding image latency depending on a kind of the encoding.

12. The system of claim 11, wherein the offset amount is set by a Software Development Kit (SDK).

13. The system of claim 8, wherein the retinal image latency is an offset of approximately 50 to 100 milliseconds.

14. The system of claim 8, wherein the processors are further configured to execute operations comprising:
determining there is a wireless video transport playback protocol, wherein a video flow includes one or more time references; and
determining latencies according to the one or more time references of the video flow.

15. A non-transitory computer-readable storage medium having instructions embodied thereon, wherein the instructions are executable by a processor to perform operations comprising:
receiving a digital multimedia file;
determining whether there is a wireless audio transport latency based on whether there is a wireless audio transport protocol for the digital multimedia file;
determining whether there is an encoding image latency based on whether the digital multimedia file is encoded;
calculating a total audio latency offset based on a retinal image latency in addition to the encoding image latency minus the wireless audio transport latency; and
delaying an audio by the total audio latency offset.

16. The non-transitory computer-readable storage medium of claim 15, wherein the instructions are executable by the processor to further perform operations comprising:
determining there is a wireless video transport playback protocol, wherein a video flow includes one or more time references; and
determining latencies according to the one or more time references of the video flow.

17. The non-transitory computer-readable storage medium of claim 15, wherein the determining of whether there is the wireless audio transport protocol includes a check for whether a processing device performing playback of the digital multimedia file is connected to a wirelessly-connected audio output.

18. The non-transitory computer-readable storage medium of claim 17, wherein the instructions are executable by the processor to further perform operations comprising:
when the audio is no longer played via the wirelessly-connected audio output, the total audio latency offset is re-adjusted to remove the wireless audio transport latency.

19. The non-transitory computer-readable storage medium of claim 15, wherein the instructions are executable by the processor to further perform operations comprising:
determining the digital multimedia file is encoded; and
electing an offset amount for the encoding image latency depending on a kind of the encoding.

20. The non-transitory computer-readable storage medium of claim 19, wherein the offset amount is set by a Software Development Kit (SDK).
